(19) United States
(12) Patent Application Publication
(10) Pub. No.: US 2022/0254125 A1
(43) Pub. Date: Aug. 11, 2022

(54) Device Views and Controls

(71) Applicant: Facebook Technologies, LLC, Menlo Park, CA (US)

(72) Inventors: Peter KOCH, Los Altos, CA (US); Jeffrey WITTHUHN, Oakland, CA (US); Marios ATHINEOS, San Francisco, CA (US); Priyanka SHARMA, Cupertino, CA (US)

(21) Appl. No.: 17/730,419

(22) Filed: Apr. 27, 2022

Related U.S. Application Data
(60) Provisional application No. 63/288,737, filed on Dec. 13, 2021.
(60) Provisional application No. 63/239,987, filed on Sep. 2, 2021.
(60) Provisional application No. 63/232,889, filed on Aug. 13, 2021.

(30) Foreign Application Priority Data
Oct. 29, 2021 (GR) 20210100742

(51) Int. Cl. G06T 19/00; G06F 3/01; G06F 3/0484; G06F 3/0481; G06T 3/60

(52) U.S. Cl. CPC G06T 19/006; G06F 3/011; G06F 3/0484; G04G 9/007; G06T 3/60; G06T 2200/24; G06F 3/0481

(57) ABSTRACT

Aspects of the present disclosure are directed to enabling viewing and controlling a mixed reality capture feed from within an artificial reality environment. Additional aspects of the present disclosure are directed to applying a rotated viewing angle to a wearable device UI, interpreting input according to the rotated viewing angle, and providing corner controls. Further aspects of the present disclosure are directed to customizing elements of an artificial reality environment based on recognition of a user's object-of-focus.

### CROSS REFERENCE TO RELATED APPLICATIONS

This application claims priority to U.S. Provisional Application Nos. 63/232,889 filed Aug. 13, 2021, 63/288,737 filed Dec. 13, 2021, 63/239,987 filed Sep. 2, 2021. Each patent application listed above is incorporated herein by reference in their entireties.

### BACKGROUND

An existing way of sharing an artificial reality (XR) experience is simply to allow other users to see a two-dimensional (2D) rendering of the XR experience from the first user's in XR point-of-view. This method of translating a XR experience of a first user (wearing an artificial reality device) onto a 2D display of a second user may be limited to allowing the second user to view what the first user views through their headset. That is, the second user may be limited to viewing a livestream of the XR environment within the first user's field of view. There also exist ways of compositing the XR experience with real-world images of the first user, captured by a camera and inserted into a rendering of the XR experience. For example, a camera may be set up to view the first user from a static or dynamic positions.

There are a number of wearable devices with UI displays. Most commonly these include smartwatches that provide functions such as communications, activity tracking, notifications, social media interfaces, etc. Typically, these wearable devices provide a UI that aligns in parallel or perpendicularly the length of the wearer's forearm. For example, for a user to view such a UI aligned perpendicular to the length of the user's forearm, the user typically raises her forearm in front of her face, holding her forearm parallel to the ground.

Artificial reality systems provide an artificial reality environment, allowing users the ability to experience different worlds, learn in new ways, and make better connections with others. Artificial reality systems can present “virtual objects,” i.e., computer-generated object representations appearing in a virtual environment. Artificial reality systems can also track user movements, e.g., a user's hands, translating a grab gesture as picking up a virtual object, etc. A user can select, move, scale/resize, skew, rotate, change colors/textures/skins of, or apply any other imaginable action to a virtual object. Some artificial reality systems can present a number of virtual objects in relation to detected environment content and context. However, these systems do not provide links between environment elements based on user intents.

### SUMMARY

Aspects of the present disclosure are directed to a mixed reality capture system enabling viewing and controlling aspects of a mixed reality capture feed from within a virtual reality environment. A mixed reality capture system places real-world people and objects in virtual reality—allowing live video footage of a virtual reality user to be composited with the artificial reality environment. Previously, users would setup a mixed reality capture camera and, whilst in the virtual environment, would not have full awareness of what is being captured by the mixed reality capture camera, requiring help from another user or that the user take off the artificial reality device. The present technology includes several embodiments that eliminate these deficiencies including: allowing the virtual reality user to control functions of the mixed reality capture camera from within the artificial reality environment; presenting a mixed reality capture camera as a virtual object within the artificial reality environment, based on the mixed reality capture's position in the real world; and showing the mixed reality capture composite feed as a video in the artificial reality environment.

Aspects of the present disclosure are also directed to wearable devices with rotated viewing angles. A rotated viewing angle for a wearable device, such as a smart watch, can align the wearable device's user interface (UI) with the user such that viewing the wearable device can be easier, faster, and causes less strain. In various implementations, the rotated viewing angle can be a default angle, a user-specified angle, or a dynamic and automatically determined angle (e.g., based on device orientation). In some cases, a viewing angle applied to a rectangular display may cause display corners to not be covered by the UI and, in these corners, additional controls can be provided.

Aspects of the present disclosure are further directed to customizing elements of an artificial reality environment based on recognition of a user's object-of-focus. An object-of-focus can be an object the user is holding, interacting with, created, has looked at for a threshold amount of time, or that another indicator of user focus suggests. Various elements in an artificial reality environment such as walls, clothing, other users, etc., can have graphic elements or “skin” applied, and the object-of-focus can be mapped to various skins which can be applied to the artificial reality environment elements. In various implementations, the mapping can be a mapping of object types to a skin defined by skin creators, a user-created mapping of between object categories to skin keywords, a mapping defined through a machine learning model that has been trained to match objects to skins, etc. In other implementations, the skin can be dynamically created using images, associated with a recognized object, in a template to create the skin.

### BRIEF DESCRIPTION OF THE DRAWINGS

FIG. 1 is an example of a UI for controlling a mixed reality capture setup from within a virtual reality environment.

FIG. 2 is a flow diagram illustrating a process used in some implementations for controlling a mixed reality capture setup from within a VR environment.

FIG. 3 is an example of a mixed reality capture camera's position and orientation being illustrated with a virtual object in a virtual reality environment.

FIG. 4 is a flow diagram illustrating a process used in some implementations for illustrating a mixed reality capture camera's position and orientation with a virtual object in an artificial reality environment.

FIG. 5 is an example of a mixed reality capture feed being streamed into a virtual reality environment to provide a mixed reality capture self-view.

FIG. 6 is a flow diagram illustrating a process used in some implementations for streaming a mixed reality capture feed into an artificial reality environment to provide a mixed reality capture self-view.

FIG. 7 is an example of a smartwatch without a rotated view angle applied.

FIG. 8 is an example of a smartwatch with a rotated view angle applied.

FIG. 9 is an example of a rotated view angle applied to a smartwatch with defined corner controls.

FIG. 10 is a flow diagram illustrating a process used in some implementations for displaying a wearable device UI with a rotated view angle.

FIG. 11 is an example of recognizing an object-of-focus for a user.

FIG. 12 is an example of skinning a car environment element based on a skin selected for an object-of-focus.

FIG. 13 is an example of skinning a wallpaper environment element based on a skin selected for an object-of-focus.

FIG. 14 is a flow diagram illustrating a process used in some implementations for applying a skin to an environment element matching an object-of-focus.

FIG. 15 is a block diagram illustrating an overview of devices on which some implementations of the disclosed technology can operate.

FIG. 16 is a block diagram illustrating an overview of an environment in which some implementations of the disclosed technology can operate.

### DESCRIPTION

Embodiments of the technology described herein can improve interactions between a virtual reality (or other artificial reality (XR)) device and a mixed reality capture setup by providing controls for the mixed reality capture setup from within the virtual reality environment (or other artificial reality environment), by displaying a virtual camera in the artificial reality environment which represents the position of a real-world camera of the mixed reality capture setup, and/or by displaying a live camera feed from the mixed reality capture setup in the artificial reality environment. A mixed reality capture setup includes at least a camera that can capture images of a user while using an artificial reality device and the mixed reality capture setup can receive a feed of the artificial reality environment. The mixed reality capture setup can segment the images of the user to exclude the background (which may be facilitated through use of a “green screen,” a machine learning model for masking user images, etc.) and can composite the segmented images of the user with the feed from the artificial reality environment. As a result, the mixed reality capture setup can provide a feed that shows a real-world image of the user in the artificial reality environment—e.g., allowing viewers of the feed to see the user as if she were a part of the artificial reality environment.

In existing systems, a mixed reality capture setup requires either a second user to help align and control the mixed reality capture camera (e.g., to keep it focused on the first user), or requires the first user to constantly remove the artificial reality device to see what the mixed reality capture camera is capturing, align it, and activate controls. However, the technology disclosed herein allows the user to understand what the camera of the mixed reality capture setup is capturing, by providing an indication of the camera's position and orientation in the artificial reality environment and showing the composited feed in the artificial reality environment. In addition, the user can physically interact with the mixed reality capture camera without having to remove her artificial reality device by virtue of having a representation of the mixed reality capture camera in the artificial reality environment. Further, through a UI with virtual camera controls provided in the artificial reality environment and linked to the mixed reality capture camera, the user can further control the mixed reality capture camera without having to exit the artificial reality environment.

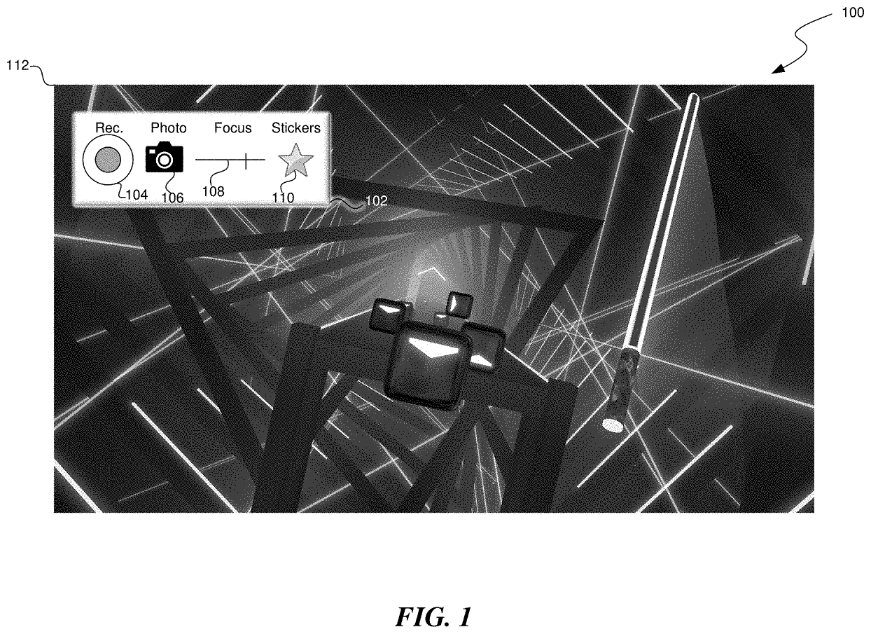

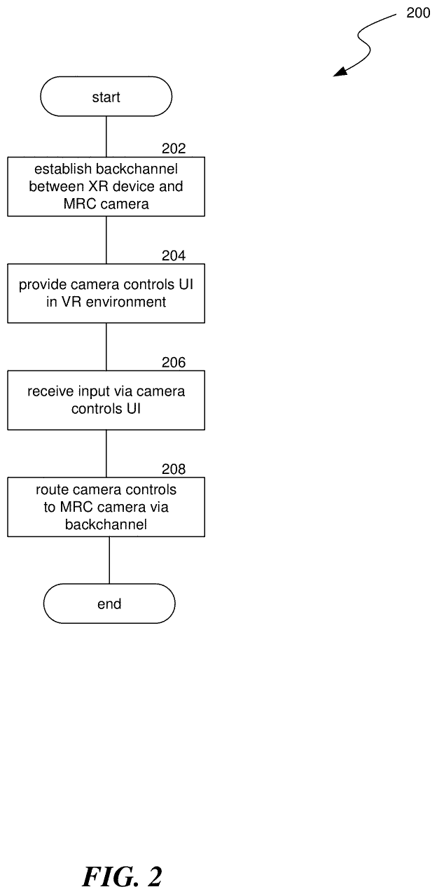

FIG. 1 is an example 100 of a UI for controlling a mixed reality capture setup from within a virtual reality environment. Example 100 includes a virtual reality environment 112 in which a user is playing a game while recording herself with a mixed reality capture setup. A UI 102 is presented in the mixed reality capture setup, providing controls that the user can activate without having to remove her virtual reality device, which result in corresponding controls being routed, through a connection between the virtual reality device and the mixed reality capture setup, to control the mixed reality capture camera and/or composite feed. In example 100, the UI 102 includes a control 104 to start/stop capture of a mixed reality capture feed, a control 106 to take an individual mixed reality capture photo, a control 108 to adjust the focus of the mixed reality capture camera, and a control 110 to add an AR sticker effect to the mixed reality capture feed. In other implementations, the UI 102 can include a number of other or additional controls, as discussed below in relation to block 204 of FIG. 2. Notably, any two or all three of example 100 and examples 300 and 500 (discussed below) can be combined to include a mixed reality capture setup control UI (such as UI 102), a virtual object showing the position an orientation of the mixed reality capture camera (such as virtual object 304), and/or a display of the composited mixed reality capture feed (such as feed 504).

FIG. 2 is a flow diagram illustrating a process 200 used in some implementations for controlling a mixed reality capture setup from within a VR environment. Process 200 can be performed by an artificial reality device, e.g., in response to loading a mixed reality capture enabled application or a mixed reality capture companion application.

At block 202, process 200 can establish a backchannel between the artificial reality device and the mixed reality capture camera. The backchannel can be established based on a pre-defined relationship between the artificial reality device and mixed reality capture setup. For example, a user can have installed a mixed reality capture application on her smart phone and signed into it using an account also associated with her artificial reality device. Though this relationship, the artificial reality device and mixed reality capture setup can establish a bi-directional channel (e.g., via Bluetooth, NFC, WiFi, etc.) Communications and commands sent over this backchannel can control features of the artificial reality device and/or mixed reality capture camera. Additional details on establishing and using communications between an artificial reality device and a mixed reality capture setup are provided in U.S. patent application Ser. No. 17/336,776, titled “Dynamic Mixed Reality Content in Virtual Reality” and filed Jun. 2, 2021, which is hereby incorporated by reference in its entirety.

At block 204, process 200 can provide a camera controls UI in the VR environment. The camera controls UI can be always-on, brough up in response to a user command (e.g., voice command, activation of a UI control, activation of a physical button, etc.), or started based on a contextual trigger (e.g., the user being in or out of focus, a timer expiring, etc.) In various implementations, the camera controls UI can include one or more controls for, e.g., starting/stopping recording; taking a photo; setting a focus; setting a capture data rate; setting a camera mode (e.g., night mode, action shots, etc.); setting camera zoom; etc. In some implementations, the Camera controls UI can also or instead include data about the mixed reality capture system such as a battery status, a status of streaming the composite feed, related comments (e.g., from a social media post including the composite feed); etc. In some yet further implementations, the camera controls UI can include controls for modifying the composite feed before it is streamed to other users, such as an option to apply person filters or AR effects (e.g., apply a fireworks animation, an overlay to add an accessory, etc.)

At block 206, process 200 can receive input via the camera controls UI, such as a selection to begin recording, change the camera's zoom setting, or add an AR “sticker” to the composite feed. At block 208, process 200 can route the received camera controls to the mixed reality capture camera via the backchannel. Transmitting the commands can cause an application in control of the mixed reality capture camera to execute them, e.g., to start or stop recording, change a camera mode or setting, add a filter or overlay for the composite feed, etc.

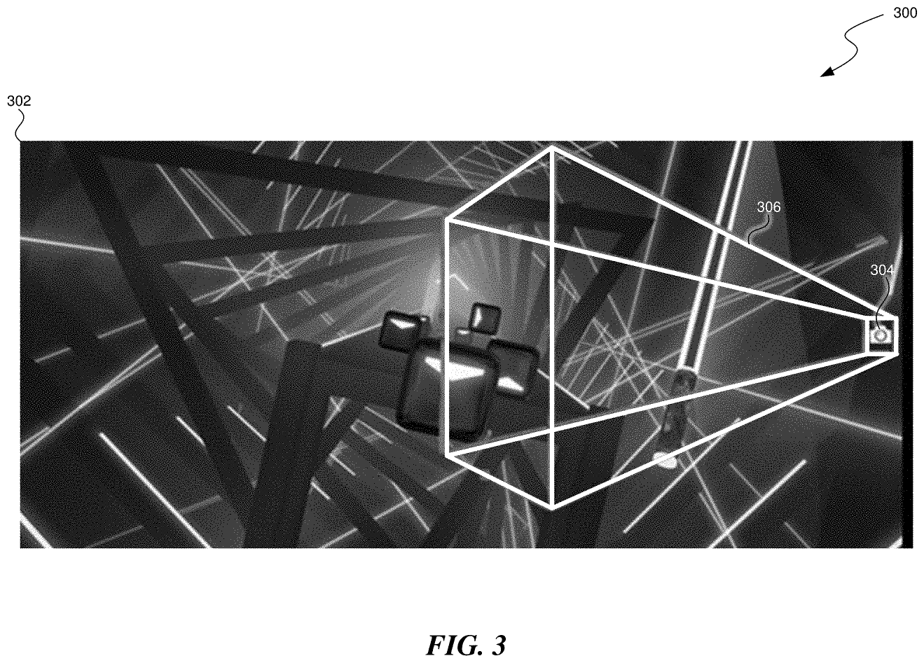

FIG. 3 is an example 300 of a mixed reality capture camera's position and orientation being illustrated with a virtual object in a virtual reality environment. In example 300, a virtual reality device has received real-world camera position and orientation data and has translated it into its coordinate system. The virtual reality device is providing virtual reality environment 302, in which it creates virtual object 304, positioned according to the translated camera position data. The virtual reality device is also showing the camera capture frustrum 306, based on the translated orientation data, illustrating to the user of the virtual reality device what area of the virtual reality environment the mixed reality capture camera is capturing.

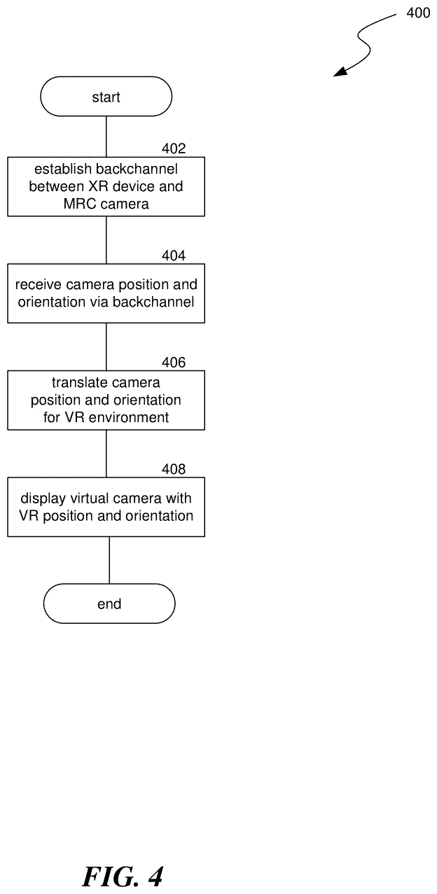

FIG. 4 is a flow diagram illustrating a process 400 used in some implementations for illustrating a mixed reality capture camera's position and orientation with a virtual object in an artificial reality environment. Process 400 can be performed on an artificial reality device, e.g., in response to loading a mixed reality capture enabled application or a mixed reality capture companion application.

At block 402, process 400 can establish a backchannel between the artificial reality device and the mixed reality capture camera. The backchannel can be established based on a pre-defined relationship between the artificial reality device and mixed reality capture setup. For example, a user can have installed a mixed reality capture application on her smart phone and signed into it using an account also associated with her artificial reality device. Though this relationship, the artificial reality device and mixed reality capture setup can establish a bi-directional channel (e.g., via Bluetooth, NFC, WiFi, etc.) Communications and commands sent over this backchannel can control features of the artificial reality device and/or mixed reality capture camera. Additional details on establishing and using communications between an artificial reality device and a mixed reality capture setup are provided in U.S. patent application Ser. No. 17/336,776, titled “Dynamic Mixed Reality Content in Virtual Reality” and filed Jun. 2, 2021.

At block 404, process 400 can receive a camera position and orientation via the backchannel. In some implementations, the mixed reality capture setup can track its physical position and orientation by creating a 3D map of the space it's in and its corresponding location. This can include a coordination between the artificial reality device and mixed reality capture setup, such that both devices are tracking themselves within the same coordinate system (in which case step 406 can be skipped). At block 406, process 400 can translate the received camera position and orientation into a virtual reality environment position and orientation. This can include using a comparison of a mapping system used by the mixed reality capture setup to that of the artificial reality device to determine a translation formula between coordinate systems used by these two devices. Application of this formula to the position and orientation coordinates from the mixed reality capture setup can translate these coordinates into virtual reality environment position and orientation coordinates. In some implementations, instead of receiving and translating the camera position and orientation from the mixed reality capture setup, the artificial reality device can use images it captures of its surroundings to track a position of the mixed reality capture camera in relation to an artificial reality environment origin point.

At block 408, process 400 can display a virtual camera with the virtual reality environment position and orientation. This can include placing a virtual object (e.g., a 3D model of a camera) at the determined position and with the determined orientation. In some cases, the virtual object can also be shown with a frustrum or other indication of an area captured by the mixed reality capture camera.

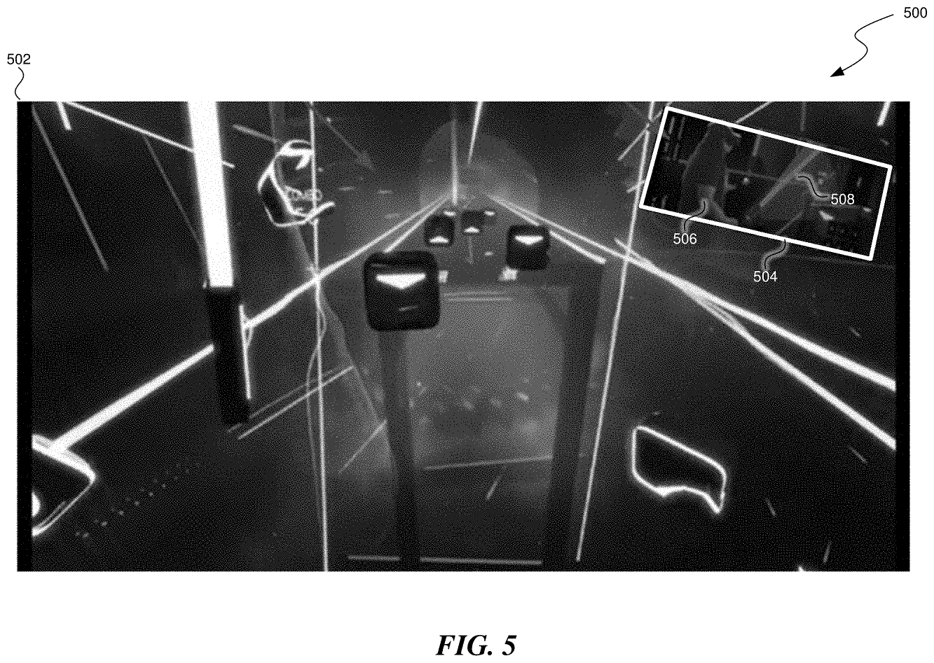

FIG. 5 is an example 500 of a mixed reality capture feed being streamed into a virtual reality environment to provide a mixed reality capture self-view. In example 500, a virtual reality device is providing virtual reality environment 502 in which a user is playing a game. A mixed reality capture setup is capturing real-world images of the user while he plays the game and is compositing them with a feed from the virtual reality device of the virtual reality environment 502, creating composited feed 504—including both real-world images 506 of the user and virtual elements such as virtual object (a saber) 508. The mixed reality capture setup is sending the composited feed 504 back to the virtual reality device, which displays it in the virtual reality environment 502, allowing the user to view it, change his or the camera's position, adjust camera controls (e.g., using UI 102 of FIG. 1), etc.

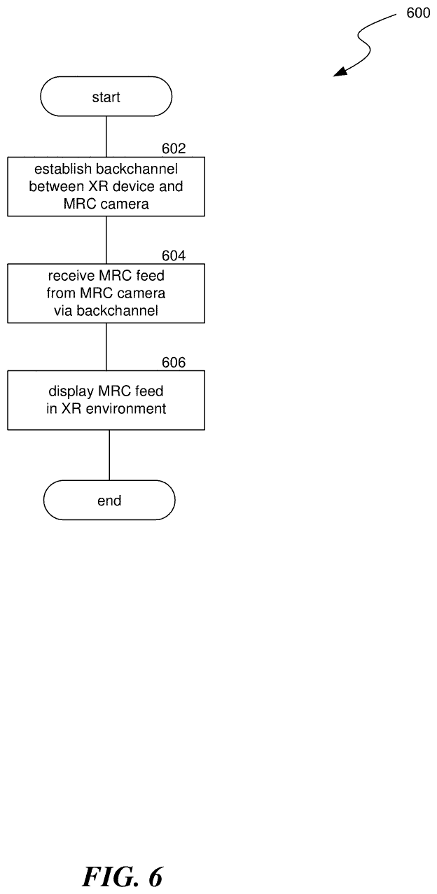

FIG. 6 is a flow diagram illustrating a process 600 used in some implementations for streaming a mixed reality capture feed into an artificial reality environment to provide a mixed reality capture self-view. Process 600 can be performed on an artificial reality device, e.g., in response to loading a mixed reality capture enabled application or a mixed reality capture companion application.

At block 602, process 600 can establish a backchannel between the artificial reality device and the mixed reality capture camera. The backchannel can be established based on a pre-defined relationship between the artificial reality device and mixed reality capture setup. For example, a user can have installed a mixed reality capture application on her smart phone and signed into it using an account also associated with her artificial reality device. Though this relationship, the artificial reality device and mixed reality capture setup can establish a bi-directional channel (e.g., via Bluetooth, NFC, WiFi, etc.) Communications and commands sent over this backchannel can control features of the artificial reality device and/or mixed reality capture camera. Additional details on establishing and using communications between an artificial reality device and a mixed reality capture setup are provided in U.S. patent application Ser. No. 17/336,776, titled “Dynamic Mixed Reality Content in Virtual Reality” and filed Jun. 2, 2021.

At block 604, process 600 can receive a mixed reality capture feed from the mixed reality capture camera via the backchannel. This mixed reality capture feed can be the composite feed the mixed reality capture setup has created by compositing images of the user, captured by the mixed reality capture camera, onto an artificial reality environment feed provided by the artificial reality device. In some implementations, the mixed reality capture setup can encode the mixed reality capture feed (e.g., as H26x video) and stream it to the artificial reality device.

At block 606, process 600 can display the received mixed reality capture feed in the artificial reality environment. In various implementations, the mixed reality capture feed can be displayed continuously, periodically, or in response to a user command (e.g., a voice command, activation of a UI control, activation of a physical button, etc.) Similarly, in some cases, expiration of a timer or a user command can cause the mixed reality capture feed to be hidden. In various implementations, the mixed reality capture feed can be rendered as a heads-up object (e.g., at a fixed position in the user's field of view), as a body-locked object (e.g., positioned relative to the a part of the user's body so it moves with the user but is not necessarily always in the user's view), or as a world-locked object (e.g., the object is rendered so as to appear as if it stays in the same physical location, despite movements of the artificial reality device).

A UI display system can receive a rotated view angle, display a UI according to the rotated view angle, and receive inputs and interpret them according to the rotated view angle. In various cases, the rotated view angle can be set by a user selection, by an application currently displaying content on the wearable device, according to a default value, or based on sensor data. For example, the UI display system can use input from inertial measurement unit (IMU) sensors or a camera attached to the wearable device to determine a current orientation of the wearable device, and various orientations can be pre-determined to map to a corresponding rotated view angle. An operating system, display driver, or application overlay of the wearable device can define transforms for the display such that the wearable device UI is rotated according to the rotated view angle. When an input is received, such as a swipe on a touchscreen of the wearable device, the current transform can also be applied to the input, so the input is correctly mapped to the controls being displayed.

In some cases, applying the rotation by the view angle to the display, causes unused areas of the wearable device's display and the UI display system can display and administer corner controls in one or more of these areas. For example, a physical display of a wearable device may be substantially rectangular. When the rectangular UI is displayed as rotated in the rectangular physical display, it can be reduced in size such that the rectangular UI fits within the rectangular physical display when rotated. However, this will cause the corners of the rectangular physical display to be unused and the UI display system can fill these areas with controls, which may change depending on the context such as what applications are running on the wearable device.

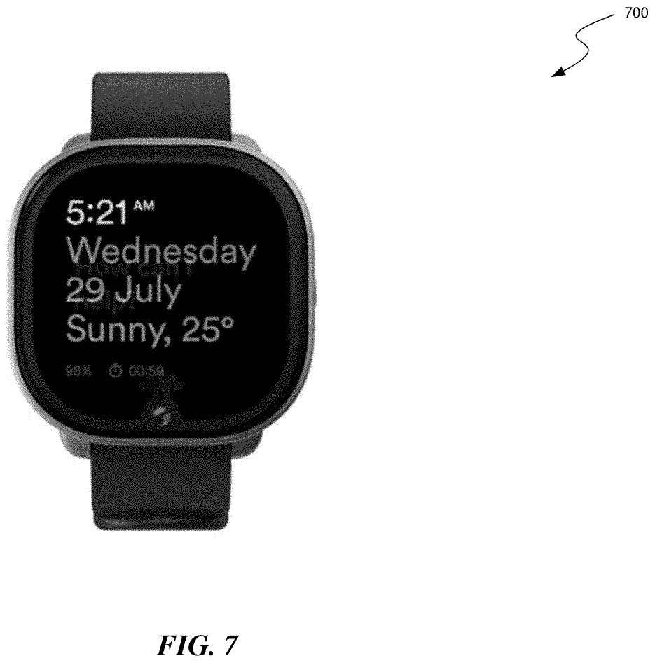

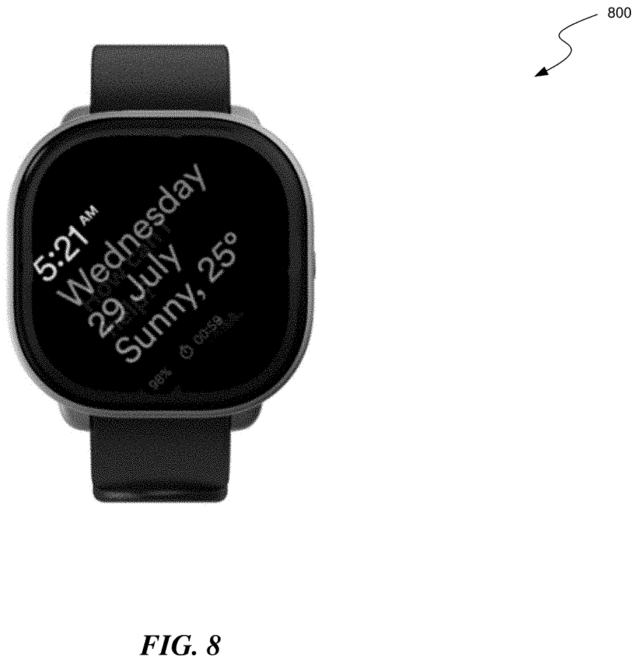

FIG. 7 is an example 700 of a smartwatch without a rotated view angle applied. Example 700 illustrates the UI of the smartwatch prior to application of any rotated view angle, thus a user viewing the smartwatch UI would likely raise her arm in front of herself to be able to clearly view the displayed graphics. FIG. 8 is an example 800 of a smartwatch with a rotated view angle applied. In example 800, the smartwatch UI has been rotated by a rotated view angle of 45 degrees. The smartwatch UI has also been reduced in size to allow the rotated UI to fit on the physical display of the smartwatch. With the rotated view angle applied, a user of the smartwatch shown in example 800 would be able to glance at the smartwatch and easily read displayed text and other displayed graphics without having to fully raise her arm. Thus, the rotated view angle can increase ease of use and eliminate repeated movements of constantly raising the user's arm.

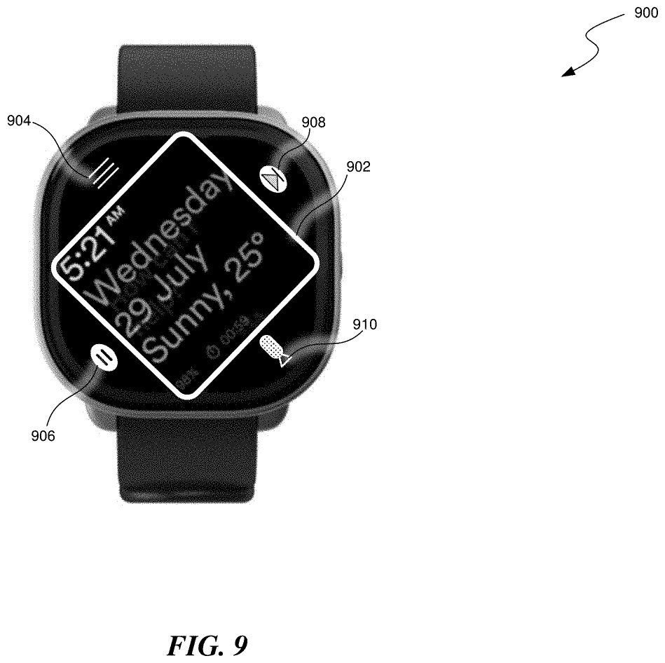

FIG. 9 is an example 900 of a rotated view angle applied to a smartwatch with defined corner controls. In example 900, a UI 902 of the smartwatch has been rotated by 45 degrees. In example 900, an outline of the UI 902 has been provided for illustrative purposes, but such an outline may not be shown on the smartwatch display. The rotation of the UI 902 has provided four areas in the corners of the smartwatch display that would otherwise be unused. In response to this, the UI display system has selected four corner controls 904-310 to place in these corners. The corner controls 904 and 910 are default corner controls (a menu control 904 and a voice command control 910). The corner controls 906 and 908 are contextual controls that correspond to an audio application executing in the background of the smartwatch. The corner control 906 provides a control to pause/play the audio from the audio application and the corner control 908 provides a control to go to a next song in the audio application.

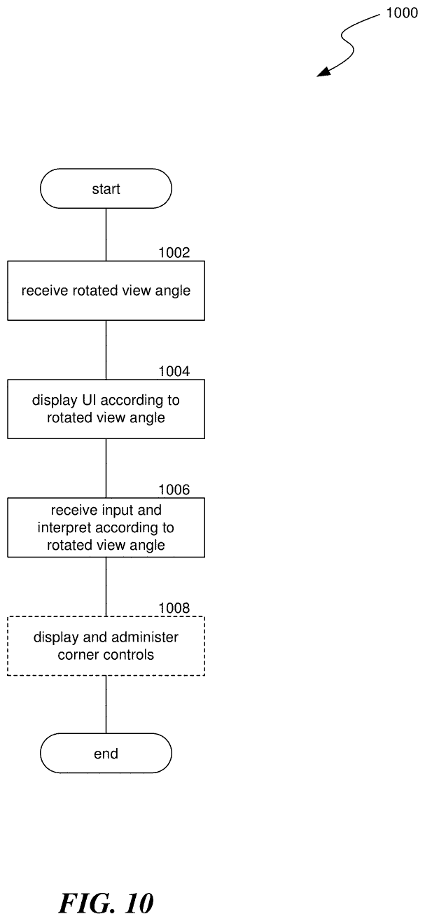

FIG. 10 is a flow diagram illustrating a process 1000 used in some implementations for displaying a wearable device UI with a rotated view angle. In some implementations, process 1000 can be performed on a smart wearable device, such as a smartwatch. At block 1002, process 1000 can receive a rotated view angle. In some implementations, the rotated view angle can be user selected. In other cases, the rotated view angle can be set by an application currently in control of the wearable device display. In yet further implementations, the rotated view angle can be a default value, such as 20, 45, or 60 degrees. In some cases, the rotated view angle can be dynamically set based on a determined current orientation of the wearable device. For example, process 1000 can have a predefined mapping of device orientations to corresponding rotated view angles or a formula that produces a rotated view angle from device orientation parameters. As a more specific example, when process 1000 determines that the wearable device is being held such that the wearer's arm is parallel to the ground, the rotated view angle can be 90 degrees whereas at other times the rotated view angle can be 45 degrees. In some implementations, process 1000 can determine the orientation of the wearable device based on IMU data and/or data from a camera of the wearable device.

At block 1004, process 1000 can display a UI according to the rotated view angle received at block 1002. This can include applying a transform to the output to align the output to the rotated view angle. In some cases, the display can use a pentile sub-pixel arrangements placed at 45 degrees. In such cases, a 45 degree rotated view angle can result in alignment between the UI and the pixel arrangement, resulting in a decrease in tearing, the need for anti-aliasing, and drawing artifacts. In some implementations, process 1000 can decrease the size of the UI to accommodate fitting the rotated UI on the physical display of the wearable device. For example, where the UI and the physical display are both substantially rectangular, the rotated display may need to be decreased in size to fit with its corners aligned away from the corners of the physical display. In some cases, process 1000 may clip the corners from the UI to make it better fit the physical display. In these cases, process 1000 may coordinate with the application outputting to the display so the application does not output to the clipped areas. In round displays, such clipping of corners or decrease in size is not performed.

At block 1006, process 1000 can receive input and interpret it according to the rotated view angle. In some cases, process 1000 can accomplish this by applying the transform, used to output the UI at block 1004, to the input received at block 1006. For example, swipes (e.g., up/down, left/right) or scrolling input can be interpreted according to the rotated view angle (e.g., a swipe from one corner to the opposite can be interpreted as a left/right swipe when a +45/−45 degrees angle is applied).

While any block in process 1000 can be removed or rearranged in various implementations, block 1008 is shown in dashed lines to indicate there are specific instances where block 1008 is skipped. At block 1008, process 1000 can display and administer corner controls. Corner controls can be provided when the rotated view angle applied to the UI causes areas of the physical display of the wearable device to not be used. In some of these cases, process 1000 can select one or more controls—referred to herein as corner controls—for these areas. In some implementations, one or more of these corner controls can be default controls, such as a control for selecting settings, accessing a main menu, or for activating voice commands. In other cases, one or more of these corner controls can be selected depending on the current context, such as what applications are running on the wearable device. For example, when a browsing UI is being displayed, the corner controls can include forward/backward controls; when the wearable device is in control of an audio player, the corner controls can include play/pause and next track controls; when the display includes a modal dialog, the corner controls can include responses options such as yes/no or OK. Following block 1008, process 1000 can end (to be repeated as needed, e.g., as additional rotated view angles are received).

An environment skinning system can add custom skins to environment elements according to which object (real or virtual) a user is, or has recently, focused on. The environment skinning system can determine which object is the user's focus (i.e., an “object-of-focus”) based on what the user is holding, what object the user is looking at for above a threshold amount of time, what virtual object the user has instantiated, what object the user has interacted with, etc. In some cases, an object-of-focus can be an object that was recently (within a threshold time) the user's focus. For example, a user may pick up a phone, making it the object-of-focus. Within a threshold time of 15 minutes, a brand of the phone can be presented as an overlay on a white t-shirt of a person in the artificial reality environment.

Once an object-of-focus is identified, the environment skinning system can determine if any environment element in the artificial reality environment can be skinned based on the object-of-focus. The environment skinning system can make this determination by checking whether any such environment elements exist in the artificial reality environment within a threshold time of identifying the object-of-focus. The environment skinning system can use one of several methods to select a skin corresponding to the object-of-focus for an eligible environment element. In some implementations, the environment skinning system can check a mapping of object types to a skin (e.g., defined by a creator of the skin) to determine if an eligible environment element can be skinned according to the object-of-focus. In other implementations, the environment skinning system can check a mapping between object categories to skin keywords to determine if an eligible environment element can be skinned according to the object-of-focus. In further implementations, the environment skinning system can apply a machine learning model, trained to match objects to skins, to determine if an eligible environment element can be skinned according to the object-of-focus. In yet other implementations, the environment skinning system can determine if any environment elements are in the artificial reality environment that can be skinned and, if so, can dynamically create the skin by applying using one or more images, associated with the object-of-focus, in a template. In some cases, before applying a skin to an environment element, the environment skinning system can receive authorization to do so from a user.

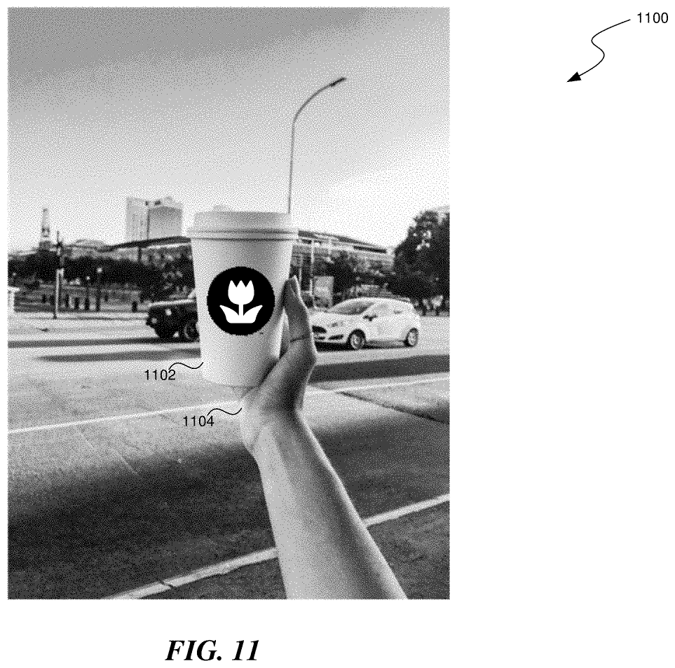

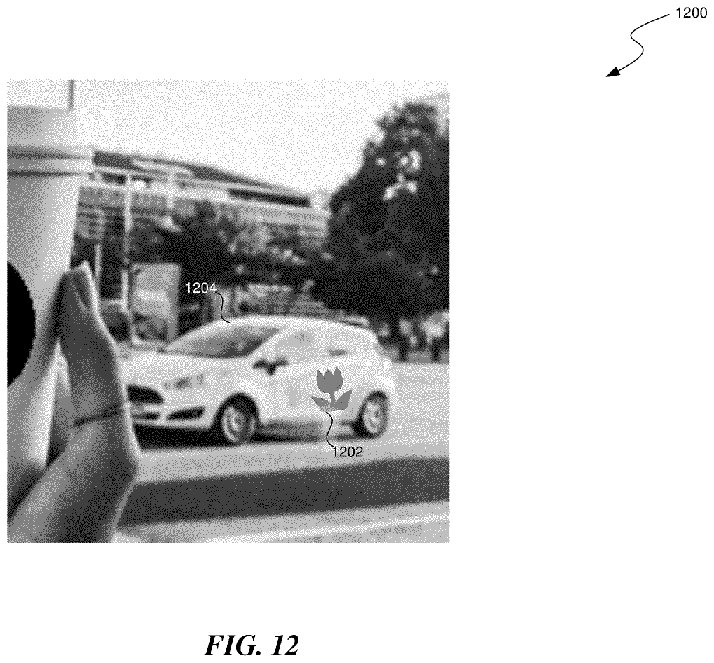

FIG. 11 is an example 1100 of recognizing an object-of-focus for a user. In example 1100, an object-of-focus is determined based on what object a user is holding. The environment skinning system is tracking the user's hand 1104 and makes the determination that hand 1104 is holding coffee cup 1102. Thus, the environment skinning system makes the coffee cup 1102 an object-of-focus. FIG. 12 is an example 1200 of skinning a car environment element based on a skin selected for an object-of-focus. Example 1200 continues example 100 where the object-of-focus 1102 was identified. The environment skinning system next determined that the object-of-focus 1102 was mapped to a skin 1202, including an image for the brand of the object-of-focus coffee cup 1102, based on a mapping defined by the creator of skin 1202. The environment skinning system further determined that a car object 1204 in view of the artificial reality device (an environment element) can be skinned with an overlay of the skin 1202. Thus, the environment skinning system adds the skin 1202 to the car environment element 1204.

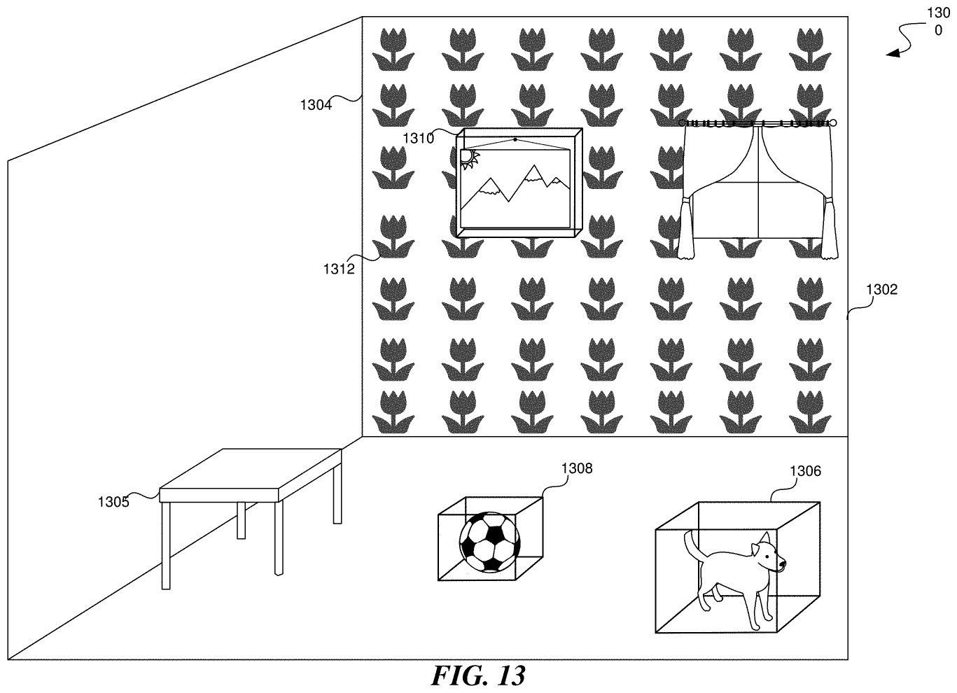

FIG. 13 is an example 1300 of skinning a wallpaper environment element based on a skin selected for an object-of-focus. Example 1300 is an alternate embodiment that also continues example 1100 where the object-of-focus 1102 was identified. The environment skinning system next determined that the object-of-focus 1102 was mapped to a skin including an image for the brand of the object-of-focus coffee cup 1102, based on an analysis of the object-of-focus coffee cup 1102, identifying a logo on the object-of-focus coffee cup 1102. In example 1300, the user has moved her hand out of view of the artificial reality device, however the determination of the object-of-focus occurred within a threshold time of 15 minutes, so the environment skinning system continues to look for environment elements to skin based on the object-of-focus coffee cup 1102. As the user enters a room 1302, the environment skinning system identifies various real objects (such as wall 1304 and table 1305) and virtual objects (such as virtual objects 1306, 1308, and 1310) and determines that the rear wall 1304 is an environment element that can be skinned with an overlay of a skin based on the object-of-focus 1102. The environment skinning system creates a skin 1312 (the skin 1312 includes all the instances of the brand on the wall 1304) as a pattern of the identified brand of the object-of-focus coffee cup 1102, by applying the brand to a wall skin template. The environment skinning system then adds the skin 1312 to the wall environment element 1304.

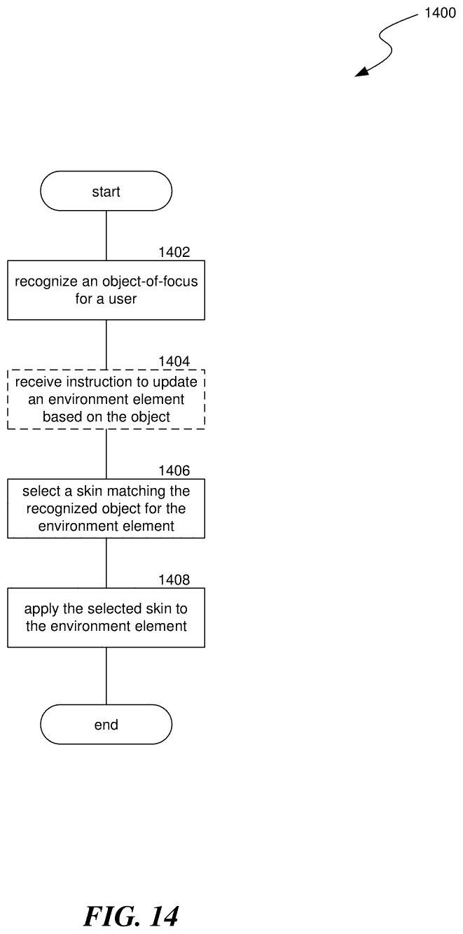

FIG. 14 is a flow diagram illustrating a process 1400 used in some implementations for applying a skin to an environment element matching an object-of-focus. In various implementations, process 1400 can be performed by an operating system, shell application, or other third-party application in control of an artificial reality environment. Process 1400 can be initiated as part of executing such an operating system, shell application, or third-party application.

At block 1402, process 1400 can recognize an object-of-focus for a user. In some implementations, process 1400 can monitor various body parts such a user's hands and what they are holding or a user's gaze and what they are looking at to determine the object-of-focus. For example, one or more cameras included in an artificial reality device or external cameras, can monitor the positions and poses of the user's hands to determine gestures and other hand and body motions or can model the user's head and/or eyes to determine where the user's gaze is focused. As a more specific example, hand postures can be identified using input from external facing cameras that capture depictions of user hands, or hand postures can be based on input from a wearable device such as a glove or wristband that tracks aspects of the user's hands. In some implementations, such inputs can be interpreted by applying the input to a machine learning model trained to identify hand postures and/or gestures based on such input. In other implementations, process 1400 can determine an object-of-focus based on what the user is interacting with, either directly with their hands or indirectly such as by directing a ray or other remote interaction tool at an object. In some implementations, a user action can cause a virtual object to be created or instantiated into an artificial reality environment, and process 1400 can identify such an object as the object-of-focus. In some embodiments, instead of or in addition to identifying an object-of-focus, process 1400 can identify a user's mood or other context (e.g., based on a tone of voice, posts to social media, body language from monitored body positions, etc.) and the mappings or otherwise selection of a skin (discussed at block 1406 below) can alternately or in addition use this mood or context determination as input.

While any block can be removed or rearranged in various implementations, block 1404 is shown in dashed lines to indicate there are specific instances where block 1404 is skipped. At block 1404, process 1400 can receive a user instruction to update an environment element based on the recognized object. For example, when an object-of-focus is identified or when it is paired with an environment element to skin, process 1400 can present an option to the user, asking if the user wants to apply a skin based on the object-of-focus to her environment. If the user rejects this option, process 1400 can end (though it may be performed again when a next object-of-focus is identified).

At block 1406, process 1400 can select a skin matching the recognized object for an environment element. In various implementations, environment elements can be any real or virtual object in view of an artificial reality device. Examples of environment elements include flat surfaces such as a wall, tabletop, or floor; an article of clothing; an open volume; an identified person; an animal (e.g., pet); etc. In some cases, an environment element can be a combination of surfaces, such as multiple walls, a ceiling, and/or a floor in a room. In some implementations, the object-of-focus can be matched to a skin for an environment element by determining which skins are available for the object-of-focus and locating any environment elements eligible to have one of those skins applied. In other implementations, the object-of-focus can be matched to a skin for an environment element by identifying an environment element that is eligible to have a skin applied and selecting or creating, based on the object-of-focus, a skin for that type of environment element. As more specific examples: process 1400 can access a mapping of various objects-of-focus to skins, can apply a machine learning model trained to receive a representation of an object-of-focus and produce an identification of a skin, or can dynamically generate a skin for an object-of-focus by selecting an image associated with the object-of-focus (e.g., an image of the object-of-focus itself or an image mapped to the object-of-focus or to a type or label identified for the object-of-focus). In some cases, a dynamically generated skin can be the associated image or one or more such associated images can be used in a template, which may be a generic template, or a template defined for an environment element to which the skin will be applied.

At block 1408, process 1400 can apply the selected skin to the environment element. For example, process 1400 can add the skin as an overlay on a real-world object, modify a virtual object to incorporate the skin, apply the skin as a virtual object positioned relative to a real or virtual object, etc. For example, an environment element may be all four walls and a ceiling in a room, and applying the selected skin can include adding a “wallpaper” effect, based on the object-of-focus, to all five surfaces. Process 1400 can then end (but can be repeated as additional objects-of-focus and/or environment elements are identified).

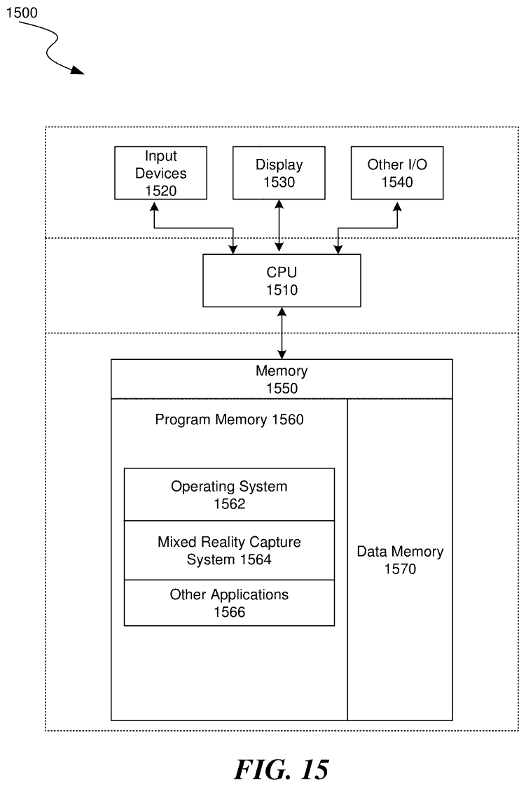

FIG. 15 is a block diagram illustrating an overview of devices on which some implementations of the disclosed technology can operate. The devices can comprise hardware components of a device 1500. Device 1500 can include one or more input devices 1520 that provide input to the Processor(s) 1510 (e.g., CPU(s), GPU(s), HPU(s), etc.), notifying it of actions. The actions can be mediated by a hardware controller that interprets the signals received from the input device and communicates the information to the processors 1510 using a communication protocol. Input devices 1520 include, for example, a mouse, a keyboard, a touchscreen, an infrared sensor, a touchpad, a wearable input device, a camera- or image-based input device, a microphone, or other user input devices.

Processors 1510 can be a single processing unit or multiple processing units in a device or distributed across multiple devices. Processors 1510 can be coupled to other hardware devices, for example, with the use of a bus, such as a PCI bus or SCSI bus. The processors 1510 can communicate with a hardware controller for devices, such as for a display 1530. Display 1530 can be used to display text and graphics. In some implementations, display 1530 provides graphical and textual visual feedback to a user. In some implementations, display 1530 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1540 can also be coupled to the processor, such as a network card, video card, audio card, USB, firewire or other external device, camera, printer, speakers, CD-ROM drive, DVD drive, disk drive, or Blu-Ray device.

In some implementations, the device 1500 also includes a communication device capable of communicating wirelessly or wire-based with a network node. The communication device can communicate with another device or a server through a network using, for example, TCP/IP protocols. Device 1500 can utilize the communication device to distribute operations across multiple network devices.

The processors 1510 can have access to a memory 1550 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1550 can include program memory 1560 that stores programs and software, such as an operating system 1562, mixed reality capture system 1564, and other application programs 1566, e.g., for device views and controls. Memory 1550 can also include data memory 1570, e.g., camera feeds, positioning information, artificial reality environment data, UI graphics, camera control interfaces, configuration data, settings, user options or preferences, etc., which can be provided to the program memory 1560 or any element of the device 1500.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like. In some implementations, multiple devices can work in concert to provide the disclosed technology, each of which can be a version of device 1500. For example, a first device 1500 can be an artificial reality device providing an artificial reality environment for a user while a second device 1500 can be a mixed reality capture system with a camera capturing images of the user to be composited with the artificial reality environment.

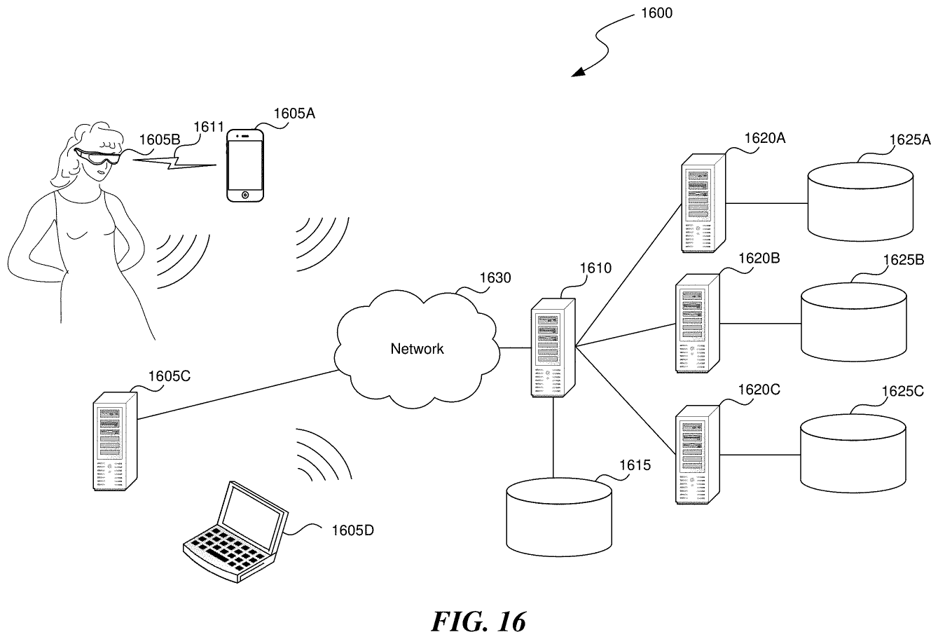

FIG. 16 is a block diagram illustrating an overview of an environment 1600 in which some implementations of the disclosed technology can operate. Environment 1600 can include one or more client computing devices 1605A-D, examples of which can include device 1500. Client computing devices 1605 can operate in a networked environment using logical connections through network 1630 to one or more remote computers, such as a server computing device. In some implementations, client computing device 16058 can be an artificial reality device in communication with a mixed reality capture device 1605A via local networking 1611. In some such implementations, the artificial reality device 16058 and the mixed reality capture device 1605A can provide the systems and methods described above, which may be in conjunction with services provided by other elements of FIG. 16.

In some implementations, server 1610 can be an edge server which receives client requests and coordinates fulfillment of those requests through other servers, such as servers 1620A-C. Server computing devices 1610 and 1620 can comprise computing systems, such as device 1500. Though each server computing device 1610 and 1620 is displayed logically as a single server, server computing devices can each be a distributed computing environment encompassing multiple computing devices located at the same or at geographically disparate physical locations. In some implementations, each server 1620 corresponds to a group of servers.

Client computing devices 1605 and server computing devices 1610 and 1620 can each act as a server or client to other server/client devices. Server 1610 can connect to a database 1615. Servers 1620A-C can each connect to a corresponding database 1625A-C. As discussed above, each server 1620 can correspond to a group of servers, and each of these servers can share a database or can have their own database. Databases 1615 and 1625 can warehouse (e.g., store) information. Though databases 1615 and 1625 are displayed logically as single units, databases 1615 and 1625 can each be a distributed computing environment encompassing multiple computing devices, can be located within their corresponding server, or can be located at the same or at geographically disparate physical locations.

Network 1630 can be a local area network (LAN) or a wide area network (WAN), but can also be other wired or wireless networks. Network 1630 may be the Internet or some other public or private network. Client computing devices 1605 can be connected to network 1630 through a network interface, such as by wired or wireless communication. While the connections between server 1610 and servers 1620 are shown as separate connections, these connections can be any kind of local, wide area, wired, or wireless network, including network 1630 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following:

A computing system for viewing and/or controlling aspects of a mixed reality capture feed from within a virtual reality environment, the system comprising: one or more processors; and one or more memories storing instructions that, when executed by the one or more processors, cause the computing system to perform a process comprising: establishing a backchannel between an artificial reality device and a mixed reality capture camera; receiving a camera position and orientation via the backchannel; translating the received camera position and orientation into a virtual reality environment position and orientation; and displaying a virtual camera with the virtual reality environment position and orientation.

A computer-readable storage medium for viewing and/or controlling aspects of a mixed reality capture feed from within a virtual reality environment, storing instructions that, when executed by a computing system, cause the computing system to perform a process comprising: establishing a backchannel between an artificial reality device and a mixed reality capture camera; receiving a mixed reality capture feed from a mixed reality capture camera via the backchannel; and displaying the mixed reality capture feed in the virtual reality environment.

I/We claim:

1. A method for enabling viewing and/or controlling aspects of a mixed reality capture feed from within a virtual reality environment, the method comprising:
establishing a backchannel between an artificial reality device and a mixed reality capture camera;
providing a camera controls UI in the virtual reality environment;
receiving input via the camera controls UI; and
routing the received camera controls to the mixed reality capture camera via the backchannel.

2. A method for administering a wearable device UI with a rotated viewing angle, the method comprising:
receiving a rotated viewing angle;
displaying the UI according to the rotated viewing angle; and
receiving wearable device input and interpreting the input according to the rotated viewing angle.

3. A method for customizing elements of an artificial reality environment based on recognition of a user's object-of-focus, the method comprising:
recognizing an object-of-focus for a user;
selecting a skin matching the object-of-focus for an environment element; and
applying the selected skin to the environment element.
